(19) United States
(12) Patent Application Publication
(10) Pub. No.: US 2024/0254330 A1
(43) Pub. Date: Aug. 1, 2024

(54) Thermoplastic Resin Composition and Molded Product Manufactured Therefrom

(71) Applicant: LOTTE CHEMICAL CORPORATION, Seoul (KR)

(72) Inventors: Min Soo LEE, Uiwang-si (KR); Chan Moo PARK, Uiwang-si (KR); Yeong Deuk SEO, Uiwang-si (KR); Sang Hwa LEE, Uiwang-si (KR)

(21) Appl. No.: 18/565,237

(22) PCT Filed: May 4, 2022
(86) PCT No.: PCT/KR2022/006390

§ 371 Date: Nov. 29, 2023

(30) Foreign Application Priority Data
May 31, 2021 (KR) 10-2021-0069846

(51) Int. Cl. C08L 67/02; C08G 63/183; C08J 5/04; C08K 7/14

(52) U.S. Cl. CPC C08L 67/02; C08G 63/183; C08J 5/043; C08K 7/14; C08J 2367/02; C08K 2201/016; C08L 2201/08; C08L 2205/03

(57) ABSTRACT

A thermoplastic resin composition of the present invention comprises: approximately 100 parts by weight of a polyester resin; approximately 7-25 parts by weight of a polycarbonate resin; approximately 30-110 parts by weight of a flat glass fiber; approximately 3-13 parts by weight of an epoxy-modified olefin-based polymer; and approximately 0.2-10 parts by weight of a maleic anhydride-modified polyolefin, wherein the weight ratio of the epoxy-modified olefin-based polymer and the maleic anhydride-modified polyolefin is approximately 1:0.1 to 1:1. The thermoplastic resin composition has excellent metal bonding property, impact resistance, stiffness, heat stability, balance of physical properties thereof, and the like.

### TECHNICAL FIELD

The present invention relates to a thermoplastic resin composition and a molded article produced therefrom. More particularly, the present invention relates to a thermoplastic resin composition having good properties in terms of metal adhesion, impact resistance, rigidity, thermal stability, and balance therebetween, and a molded article produced therefrom.

### BACKGROUND ART

As engineering plastics, a polyester resin and a blend of a polyester resin and a polycarbonate resin exhibit useful properties and are applied to various fields including interior and exterior materials for electric/electronic products. However, the polyester resin has problems of low crystallization rate, low mechanical strength, and low impact strength.

Thus, various attempts have been made to improve mechanical properties including impact resistance and rigidity of the polyester resin by adding additives such as inorganic fillers to the polyester resin. For example, polybutylene terephthalate (PBT) resins reinforced by inorganic fillers, such as glass fibers, are frequently used as materials for automotive parts and the like. However, such materials have a limitation in improvement in impact resistance, rigidity, and the like and exhibit deterioration in metal adhesion and the like.

Therefore, there is a need for development of a thermoplastic resin composition having good properties in terms of metal adhesion, impact resistance, rigidity, thermal stability, and balance therebetween.

The background technique of the present invention is disclosed in Korean Patent Registration No. 10-0709878.

### DISCLOSURE

### Technical Problem

It is an object of the present invention to provide a thermoplastic resin composition having good properties in terms of metal adhesion, impact resistance, rigidity, thermal stability, and balance therebetween.

It is another object of the present invention to provide a molded article formed from the thermoplastic resin composition.

The above and other objects of the present invention can be achieved by embodiments of the present invention described below.

### Technical Solution

1. One aspect of the present invention relates to a thermoplastic resin composition. The thermoplastic resin composition comprises: about 100 parts by weight of a polyester resin; about 7 parts by weight to about 25 parts by weight of a polycarbonate resin; about 30 parts by weight to about 110 parts by weight of flat glass fibers; about 3 parts by weight to about 13 parts by weight of an epoxy-modified olefin polymer; and about 0.2 parts by weight to about 10 parts by weight of a maleic anhydride-modified polyolefin, wherein the epoxy-modified olefin polymer and the maleic anhydride-modified polyolefin are present in a weight ratio of about 1:0.1 to about 1:1.
2. In embodiment 1, the polyester resin may comprise at least one of polybutylene terephthalate, polyethylene terephthalate, and polycyclohexylenedimethylene terephthalate.
3. In embodiment 1 or 2, the flat glass fibers may have a rectangular or elliptical cross-section, a cross-sectional aspect ratio (cross-sectional major diameter/cross-sectional minor diameter) of about 1.5 to about 10, and a minor diameter of about 2 μm to about 10 μm.
4. In embodiments 1 to 3, the epoxy-modified olefin polymer may comprise at least one of glycidyl (meth)acrylate-modified polyethylene, a glycidyl (meth)acrylate-modified ethylene-butyl acrylate copolymer, and a glycidyl (meth)acrylate-modified ethylene-methyl acrylate copolymer.
5. In embodiments 1 to 4, the maleic anhydride-modified polyolefin may comprise at least one of maleic anhydride-modified polypropylene, maleic anhydride-modified polyethylene, and maleic anhydride-modified polybutylene.
6. In embodiments 1 to 5, the thermoplastic resin composition may have a metal adhesion strength of about 35 MPa to about 50 MPa, as measured with respect to an aluminum-based metal specimen in accordance with ISO 19095.
7. In embodiments 1 to 6, the thermoplastic resin composition may have a dart impact strength of about 76 cm to about 120 cm, as determined by measuring a height from which dropping a 500 g dart causes cracking of a 2 mm thick specimen in accordance with the DuPont drop test method, and a notched Izod impact strength of about 12.5 kgf cm/cm to about 20 kgf cm/cm, as measured on a ⅛″ thick specimen in accordance with ASTM D256.
8. In embodiments 1 to 7, the thermoplastic resin composition may have a flexural modulus of about 80,000 kgf/cm² to about 140,000 kgf/cm², as measured on a ¼″ thick specimen at a rate of 2.8 mm/min in accordance with ASTM D790.
9. In embodiments 1 to 8, the thermoplastic resin composition may have a tensile strength retention rate of about 80% or more, as calculated according to Equation 1.

$$Tensile strength retention rate ( \% ) = {TS}_{1} / {TS}_{0} \times 100 \qquad [ Equation 1 ]$$

where TS₀ is an initial tensile strength of a 3.2 mm thick specimen, as measured in accordance with ASTM D638, and TS₁ is a tensile strength of the specimen, as measured in accordance with ASTM D638 after the specimen is left in an oven at 310° C. for 3 minutes.
10. Another aspect of the present invention relates to a molded article. The molded article is formed of the thermoplastic resin composition according to any one of embodiments 1 to 9.
11. A further aspect of the present invention relates to a composite material. The composite material comprises: a plastic member as the molded article according to embodiment 10; and a metal member adjoining the plastic member.
12. In embodiment 11, the metal member may directly adjoin the plastic member without a bonding agent interposed therebetween.
13. In embodiment 11 or 12, the metal member may comprise at least one of aluminum, titanium, iron, and zinc.
14. In embodiments 11 to 13, the metal member may comprise aluminum and the plastic member may have a metal adhesion strength of about 35 MPa to about 50 MPa, as measured with respect to the metal member in accordance with ISO 19095.
15. In embodiments 11 to 14, the plastic member may have a dart impact strength of about 76 cm to about 120 cm, as determined by measuring a height from which dropping a 500 g dart causes cracking of a 2 mm thick specimen in accordance with a DuPont drop impact test, a notched Izod impact strength of about 12.5 kgf cm/cm to about 20 kgf cm/cm, as measured on a ⅛″ thick specimen in accordance with ASTM D256, a flexural modulus of about 80,000 kgf/cm² to about 140,000 kgf/cm², as measured on a ¼″ thick specimen at a rate of 2.8 mm/min in accordance with ASTM D790, and a tensile strength retention rate of about 80% or more, as calculated according to Equation 1.

$$Tensile strength retention rate ( \% ) = {TS}_{1} / {TS}_{0} \times 100 \qquad [ Equation 1 ]$$

where TS₀ is an initial tensile strength of a 3.2 mm thick specimen, as measured in accordance with ASTM D638, and TS₁ is a tensile strength of the specimen, as measured in accordance with ASTM D638 after the specimen is left in an oven at 310° C. for 3 minutes.

### Advantageous Effects

The present invention provides a thermoplastic resin composition having good properties in terms of metal adhesion, impact resistance, rigidity, thermal stability, and balance therebetween and a molded article formed therefrom.

### BEST MODE

Hereinafter, embodiments of the present invention will be described in detail.

A thermoplastic resin composition according to the present invention comprises: (A) a polyester resin; (B) a polycarbonate resin; (C) flat glass fibers; (D) an epoxy-modified olefin polymer; and (E) a maleic anhydride-modified polyolefin.

As used herein to represent a specific numerical range, “a to b” means “≥a and ≤b”.

### (A) Polyester Resin

The polyester resin according to the present invention may be a polyester resin used in typical thermoplastic resin compositions. For example, the polyester resin may be obtained by polycondensation of a dicarboxylic acid component with a diol component, wherein: the dicarboxylic acid component may include aromatic dicarboxylic acids, such as terephthalic acid (TPA), isophthalic acid (IPA), 1,2-naphthalene dicarboxylic acid, 1,4-naphthalene dicarboxylic acid, 1,5-naphthalene dicarboxylic acid, 1,6-naphthalene dicarboxylic acid, 1,7-naphthalene dicarboxylic acid, 1,8-naphthalene dicarboxylic acid, 2,3-naphthalene dicarboxylic acid, 2,6-naphthalene dicarboxylic acid, 2,7-naphthalenedicarboxylic acid and the like, aromatic dicarboxylates, such as dimethyl terephthalate (DMT), dimethyl isophthalate, dimethyl-1,2-naphthalate, dimethyl-1,5-naphthalate, dimethyl-1,7-naphthalate, dimethyl-1,7-naphthalate, dimethyl-1,8-naphthalate, dimethyl-2,3-naphthalate, dimethyl-2,6-naphthalate, dimethyl-2,7-naphthalate and the like; and the diol component may include ethylene glycol, 1,2-propylene glycol, 1,3-propylene glycol, 2,2-dimethyl-1,3-propanediol, 1,3-butanediol, 1,4-butanediol, 1,5-pentanediol, 1,5-pentanediol, 1,6-hexanediol, cycloalkylene diol, and the like.

In some embodiments, the polyester resin may include polyethylene terephthalate (PET), polybutylene terephthalate (PBT), polyethylene naphthalate (PEN), polytrimethylene terephthalate (PTT), polycyclohexylenedimethylene terephthalate (PCT), and combinations thereof. Preferably, the polyester resin includes polybutylene terephthalate, polyethylene terephthalate, polycyclohexylenedimethylene terephthalate, and combinations thereof.

In some embodiments, the polyester resin may have an intrinsic viscosity [n] of about 0.5 dL/g to about 1.5 dL/g, for example, about 0.7 dL/g to about 1.3 dL/g, as measured in accordance with ASTM D2857. Within this range, the thermoplastic resin composition can have good mechanical properties.

### (B) Polycarbonate Resin

The polycarbonate resin according to the present invention serves to improve impact resistance, appearance characteristics and the like of the thermoplastic resin composition and may be a polycarbonate resin used in typical thermoplastic resin compositions. For example, the polycarbonate resin may be an aromatic polycarbonate resin prepared by reacting diphenols (aromatic diol compounds) with a precursor, such as phosgene, halogen formate, carbonic diester, and the like.

In some embodiments, the diphenols may include, for example, 4,4′-biphenol, 2,2-bis(4-hydroxyphenyl)propane, 2,4-bis(4-hydroxyphenyl)-2-methylbutane, 1,1-bis(4-hydroxyphenyl)cyclohexane, 2,2-bis(3-chloro-4-hydroxyphenyl)propane, 2,2-bis(3,5-dichloro-4-hydroxyphenyl)propane, 2,2-bis(3-methyl-4-hydroxyphenyl)propane, and 2,2-bis(3,5-dimethyl-4-hydroxyphenyl)propane, without being limited thereto. For example, the diphenols may be 2,2-bis-(4-hydroxyphenyl)propane, 2,2-bis(3,5-dichloro-4-hydroxyphenyl)propane, 2,2-bis(3-methyl-4-hydroxyphenyl)propane, 2,2-bis(3,5-dimethyl-4-hydroxyphenyl)propane, or 1,1-bis(4-hydroxyphenyl)cyclohexane, specifically 2,2-bis(4-hydroxyphenyl)propane, which is also referred to as bisphenol A.

In some embodiments, the polycarbonate resin may be a branched polycarbonate resin. For example, the polycarbonate resin may be a branched polycarbonate resin prepared by adding about 0.05 mol % to about 2 mol % of a tri- or higher polyfunctional compound, specifically a tri- or higher valent phenol group-containing compound, based on the total number of moles of the diphenols used in polymerization.

In some embodiments, the polycarbonate resin may be a homopolycarbonate resin, a copolycarbonate resin, or a blend thereof. The polycarbonate resin may be partially or completely replaced by an aromatic polyester-carbonate resin obtained by polymerization in the presence of an ester precursor, for example, a bifunctional carboxylic acid.

In some embodiments, the polycarbonate resin may have a weight average molecular weight (Mw) of about 20,000 g/mol to about 50,000 g/mol, for example, about 25,000 g/mol to about 40,000 g/mol, as measured by gel permeation chromatography (GPC). Within this range, the thermoplastic resin composition can have good properties in terms of impact resistance, fluidity (processability), and the like.

In some embodiments, the polycarbonate resin may be present in an amount of about 7 parts by weight to about 25 parts by weight, for example, about 10 parts by weight to about 20 parts by weight, relative to about 100 parts by weight of the polyester resin. If the content of the polycarbonate resin is less than about 7 parts by weight relative to about 100 parts by weight of the polyester resin, the thermoplastic resin composition can exhibit deterioration in metal adhesion, impact resistance, appearance, and the like, whereas, if the content of the polycarbonate resin exceeds about 25 parts by weight relative to about 100 parts by weight of the polyester resin, the thermoplastic resin composition can exhibit deterioration in metal adhesion, rigidity, and the like.

### (C) Flat Glass Fiber

The flat glass fibers according to the present invention serves to improve rigidity, impact resistance, metal adhesion and the like of the thermoplastic resin composition comprising the polyester resin and the polycarbonate resin together with the epoxy-modified olefin polymer and the maleic anhydride-modified polyolefin.

In some embodiments, the flat glass fibers may have a rectangular or elliptical cross-section. In addition, the flat glass fibers may have a cross-sectional aspect ratio (cross-sectional major diameter/cross-sectional minor diameter) of about 1.5 to about 10, a minor diameter of about 2 μm to about 10 μm, and a pre-processing length of about 2 mm to about 20 mm, as measured using a scanning electron microscope (SEM). Within these ranges of aspect ratio, minor diameter, and pre-processing length, the thermoplastic resin composition can have improved properties in terms of rigidity, processability, and the like.

In some embodiments, the flat glass fibers may be treated with a typical surface treatment agent.

In some embodiments, the flat glass fibers may be present in an amount of about 30 parts by weight to about 110 parts by weight, for example, about 50 parts by weight to about 100 parts by weight, relative to about 100 parts by weight of the polyester resin. If the content of the flat glass fibers is less than about 30 parts by weight relative to about 100 parts by weight of the polyester resin, the thermoplastic resin composition can exhibit deterioration in impact resistance, rigidity, thermal stability, and the like, whereas, if the content of the flat glass fibers exceeds about 110 parts by weight relative to about 100 parts by weight of the polyester resin, the thermoplastic resin composition can exhibit deterioration in metal adhesion, impact resistance, appearance, and the like.

### (D) Epoxy-Modified Olefin Polymer

The epoxy-modified olefin polymer according to the present invention serves to improve metal adhesion, impact resistance, rigidity, thermal stability and the like of the thermoplastic resin composition comprising the polyester resin and the polycarbonate resin together with the flat glass fibers and the epoxy-modified olefin polymer, and may be prepared by polymerization of an epoxy compound containing a reactive functional group with an olefin polymer (an olefin homopolymer, an olefin copolymer, an alkylene-alkyl (meth)acrylate copolymer, and the like).

In some embodiments, the epoxy compound may include glycidyl (meth)acrylate, allyl glycidyl ether, 2-methylallyl glycidyl ether, and mixtures thereof.

In some embodiments, the olefin polymer may be a homopolymer of alkylene monomers, a copolymer of alkylene monomers, and/or an alkylene-alkyl (meth)acrylate copolymer, wherein the alkylene monomers may include C₂ to C₁₀ alkylenes, for example, ethylene, propylene, isopropylene, butylene, isobutylene, octene, and the like.

In some embodiments, the epoxy-modified olefin polymer may include glycidyl (meth)acrylate-modified polyethylene, a glycidyl (meth)acrylate-modified ethylene-butyl acrylate copolymer, a glycidyl (meth)acrylate-modified ethylene-methyl acrylate copolymer, and combinations thereof.

In some embodiments, the epoxy-modified olefin polymer may have a melt-flow index of about 1 g/10 min to about 50 g/10 min, for example, about 2 g/10 min to about 25 g/10 min, as measured at a temperature of 190° C. under a load of 2.16 kg in accordance with ASTM D1238. Within this range, the thermoplastic resin composition can have good properties in terms of impact resistance and the like.

In some embodiments, the epoxy-modified olefin polymer may be present in an amount of about 3 parts by weight to about 13 parts by weight, for example, about 4 parts by weight to about 10 parts by weight, relative to about 100 parts by weight of the polyester resin. If the content of the epoxy-modified olefin polymer is less than about 3 parts by weight relative to about 100 parts by weight of the polyester resin, the thermoplastic resin composition can exhibit deterioration in impact resistance, thermal stability, and the like, whereas, if the content of the epoxy-modified olefin polymer exceeds about 13 parts by weight relative to about 100 parts by weight of the polyester resin, the thermoplastic resin composition can exhibit deterioration in metal adhesion and the like.

In some embodiments, the flat glass fibers and the epoxy-modified olefin polymer may be present in a weight ratio (C:D) of about 1:0.04 to about 1:0.2, for example, about 1:0.04 to about 1:0.15. Within this range, the thermoplastic resin composition can have further improved properties in terms of impact resistance, rigidity, and the like.

### (E) Maleic Anhydride-Modified Polyolefin

The maleic anhydride-modified polyolefin according to the present invention serves to improve metal adhesion, impact resistance, rigidity, thermal stability and the like of the thermoplastic resin composition comprising the polyester resin and the polycarbonate resin together with the flat glass fibers and the epoxy-modified olefin polymer, and may be prepared by polymerization of a polyolefin (an alkylene homopolymer) with maleic anhydride (MAH).

In some embodiments, the polyolefin may be a homopolymer of alkylene monomers, wherein the alkylene monomers may include C₂ to C₁₀ alkylenes, for example, ethylene, propylene, isopropylene, butylene, isobutylene, octene, and the like.

In some embodiments, the maleic anhydride-modified polyolefin may include maleic anhydride-modified polypropylene, maleic anhydride-modified polyethylene, maleic anhydride-modified polybutylene, and combinations thereof.

In some embodiments, the maleic anhydride-modified polyolefin may have a melt-flow index of about 5 g/10 min to about 40 g/10 min, for example, about 10 g/10 min to about 15 g/10 min, as measured at a temperature of 230° C. under a load of 2.16 kg in accordance with ASTM D1238. Within this range, the thermoplastic resin composition can have good properties in terms of impact resistance, metal adhesion, and the like.

In some embodiments, the maleic anhydride-modified polyolefin may be present in an amount of about 0.2 parts by weight to about 10 parts by weight, for example, about 0.3 parts by weight to about 5 parts by weight, specifically about 0.4 parts by weight to about 2 parts by weight, relative to about 100 parts by weight of the polyester resin. If the content of the maleic anhydride-modified polyolefin is less than about 0.2 parts by weight relative to about 100 parts by weight of the polyester resin, the thermoplastic resin composition can exhibit deterioration in impact resistance, thermal stability, metal adhesion, and the like, whereas, if the content of the maleic anhydride-modified polyolefin exceeds about 10 parts by weight relative to about 100 parts by weight of the polyester resin, the thermoplastic resin composition can exhibit deterioration in metal adhesion, impact resistance, thermal stability, and the like.

In some embodiments, the epoxy-modified olefin polymer and the maleic anhydride-modified polyolefin may be present in a weight ratio (D:E) of about 1:0.1 to about 1:1, for example, about 1:0.05 to about 1:0.5. If the weight ratio (D:E) is less than about 1:0.1, the thermoplastic resin composition can exhibit deterioration in impact resistance, thermal stability, metal adhesion, and the like, whereas, if the weight ratio (D:E) exceeds about 1:1, the thermoplastic resin composition can exhibit deterioration in impact resistance, thermal stability, metal adhesion, and the like.

The thermoplastic resin composition according to the present invention may further comprise additives used in typical thermoplastic resin compositions. The additives may include, for example, impact modifiers, flame retardants, antioxidants, anti-dripping agents, lubricants, release agents, nucleating agents, antistatic agents, stabilizers, pigments, dyes, and mixtures thereof, without being limited thereto. In the thermoplastic resin composition, the additives may be present in an amount of about 0.001 parts by weight to about 40 parts by weight, for example, about 0.1 parts by weight to about 10 parts by weight, relative to about 100 parts by weight of the polyester resin.

The thermoplastic resin composition according to the present invention may be prepared in pellet form by mixing the aforementioned components, followed by melt extrusion in a typical twin screw extruder at about 240° C. to about 300° C., for example, about 260° C. to about 290° C.

In some embodiments, the thermoplastic resin composition may have a metal adhesion strength of about 35 MPa to about 50 MPa, for example, about 36 MPa to about 48 MPa, as measured with respect to an aluminum-based metal specimen in accordance with ISO 19095.

In some embodiments, the thermoplastic resin composition may have a dart impact strength of about 76 cm to about 120 cm, for example, about 78 cm to about 110 cm, as determined by measuring a height from which dropping a 500 g dart causes cracking of a 2 mm thick specimen in accordance with the DuPont drop test method.

In some embodiments, the thermoplastic resin composition may have a notched Izod impact strength of about 12.5 kgf cm/cm to about 20 kgf cm/cm, for example, about 12.7 kgf cm/cm to about 17 kgf cm/cm, as measured on a ⅛″ thick specimen in accordance with ASTM D256.

In some embodiments, the thermoplastic resin composition may have a flexural modulus of about 80,000 kgf/cm² to about 140,000 kgf/cm², for example, about 80,000 kgf/cm² to about 130,000 kgf/cm², as measured on a ¼″ thick specimen at a rate of 2.8 mm/min in accordance with ASTM D790.

In some embodiments, the thermoplastic resin composition may have a tensile strength retention rate of about 80% or more, for example, about 80% to about 95%, as calculated according to Equation 1.

$$Tensile strength retention rate ( \% ) = {TS}_{1} / {TS}_{0} \times 100 \qquad [ Equation 1 ]$$

where TS₀ is an initial tensile strength of a 3.2 mm thick specimen, as measured in accordance with ASTM D638, and TS₁ is a tensile strength of the specimen, as measured in accordance with ASTM D638 after the specimen is left in an oven at 310° C. for 3 minutes.

A molded article according to the present invention is formed of the thermoplastic resin composition set forth above. The thermoplastic resin composition may be prepared in pellet form. The prepared pellets may be produced into various molded articles (products) by various molding methods such as injection molding, extrusion, vacuum molding, casting, and the like. These molding methods are well known to those skilled in the art to which the present invention pertains. The molded article has good properties in terms of metal adhesion, impact resistance, rigidity, thermal stability, and balance therebetween, and thus is useful as interior/exterior materials for electronic devices, interior/exterior materials for automobiles, and the like.

A composite material according to the present invention may comprise: a plastic member as the molded article; and a metal member adjoining the plastic member.

In some embodiments, the metal member may directly adjoin the plastic member without a bonding agent interposed therebetween.

In some embodiments, the metal member may comprise at least one of aluminum, titanium, iron, and zinc.

In some embodiments, the metal member may comprise aluminum and the plastic member may have a metal adhesion strength of about 35 MPa to about 50 MPa, for example, about 36 MPa to about 48 MPa, as measured with respect to the metal member in accordance with ISO 19095. The plastic member may have a dart impact strength of about 76 cm to about 120 cm, for example, about 78 cm to about 110 cm, as determined by measuring a height from which dropping a 500 g dart results in cracking of a 2 mm thick specimen in accordance with the DuPont drop test method, a notched Izod impact strength of about 12.5 kgf cm/cm to about 20 kgf cm/cm, for example, about 12.7 kgf cm/cm to about 17 kgf cm/cm, as measured on a ⅛″ thick specimen in accordance with ASTM D256, a flexural modulus of about 80,000 kgf/cm² to about 140,000 kgf/cm², for example, about 80,000 kgf/cm² to about 130,000 kgf/cm², as measured on a ¼″ thick specimen at a rate of 2.8 mm/min in accordance with ASTM D790, and a tensile strength retention rate of about 80% or more, for example, about 80% to about 95%, as calculated according to Equation 1.

$$Tensile strength retention rate ( \% ) = {TS}_{1} / {TS}_{0} \times 100 \qquad [ Equation 1 ]$$

where TS₀ is an initial tensile strength of a 3.2 mm thick specimen, as measured in accordance with ASTM D638, and TS₁ is a tensile strength of the specimen, as measured in accordance with ASTM D638 after the specimen is left in an oven at 310° C. for 3 minutes.

### MODE FOR INVENTION

Next, the present invention will be described in more detail with reference to some examples. It should be understood that these examples are provided for illustration only and are not to be construed in any way as limiting the present invention.

### Example

Details of components used in Examples and Comparative Examples are as follows.

### (A) Polyester Resin

A polybutylene terephthalate resin (PBT, manufacturer: Shinkong Synthetic Fibers Corporation, product name: Shinite K006, intrinsic viscosity [η]: about 1.3 dL/g) was used.

### (B) Polycarbonate Resin

A bisphenol A polycarbonate resin (PC, manufacturer: Lotte Chemical Corporation, weight average molecular weight: about 25,000 g/mol) was used.

### (C) Flat Glass Fibers

Flat glass fibers (manufacturer: Nittobo Co., Ltd., product name: CSG 3PA-820, minor diameter: about 7 μm, cross-sectional aspect ratio: about 4, pre-processing length: about 3 mm) were used.

### (D) Epoxy-Modified Olefin Polymer

Glycidyl methacrylate-modified polyethylene (PE-GMA, manufacturer: Sumitomo Chemical Co., Ltd., product name: Igetabond) was used.

### (E) Maleic Anhydride-Modified Olefin Polymer

(E1) Maleic anhydride-modified polypropylene (PP-MAH, manufacturer: Fine-Blend Polymer Co., Ltd., product name: CMG9801) was used.
(E2) A maleic anhydride-modified ethylene-butene copolymer (EBR-MAH, manufacturer: Mitsui Chemicals Inc., product name: Tafmer M) was used.

### Examples 1 to 9 and Comparative Examples 1 to 11

The aforementioned components were mixed in amounts as listed in Tables 1, 2, 3, and 4, followed by extrusion at 260° C., thereby preparing a thermoplastic resin composition in pellet form. Here, extrusion was performed using a twin-screw extruder (L/D: 44, ¢: 45 mm). The prepared pellets were dried at 80° C. for 4 hours or more and then subjected to injection molding using a 6 oz. injection machine (molding temperature: 270° C., mold temperature: 120° C.), thereby preparing specimens. The prepared specimens were evaluated as to the following properties. Results are shown in Tables 1, 2, 3, and 4.

### Property Evaluation

(1) Metal adhesion strength (unit: MPa): Metal adhesion strength was measured after bonding an aluminum-based metal specimen to a specimen of the thermoplastic resin composition by insert injection molding in accordance with ISO 19095. Here, the metal specimen was an aluminum-based metal specimen subjected to TRI surface treatment (Geo Nation Co., Ltd.) to facilitate bonding between the metal specimen and the resin specimen. Each of the metal specimen and the resin specimen had a size of 1.2 cm×4 cm×0.3 cm and bonding strength therebetween was measured after bonding the specimens to have a cross-sectional bonding area of 1.2 cm×0.3 cm.
(2) Dart impact strength (unit: cm): Height from which dropping a 500 g dart causes cracking of a 2 mm thick specimen (size: 10 cm×10 cm (width×length)) was measured in accordance with the DuPont drop test method.
(3) Notched Izod impact strength (unit: kgf cm/cm): Notched Izod impact strength was measured on a ⅛″ thick specimen in accordance with ASTM D256.
(4) Flexural Modulus (unit: kgf/cm²): Flexural modulus was measured on a ¼″ thick specimen at a rate of 2.8 mm/min in accordance with ASTM D790.
(5) Tensile strength retention rate (unit: %): Tensile strength retention rate was calculated according to Equation 1.

Tensile strength retention rate (%)=TS₁/TS₀×100 [Equation 1]
where TS₀ is an initial tensile strength of a 3.2 mm thick specimen, as measured in accordance with ASTM D638, and TS₁ is a tensile strength of the specimen, as measured in accordance with ASTM D638 after the specimen is left in an oven at 310° C. for 3 minutes.

TABLE 1

| | Example | | | | |
|---|---|---|---|---|---|
| | 1 | 2 | 3 | 4 | 5 |
| (A) (parts by weight) | 100 | 100 | 100 | 100 | 100 |
| (B) (parts by weight) | 10 | 14.5 | 20 | 14.5 | 14.5 |
| (C) (parts by weight) | 92 | 92 | 92 | 50 | 100 |
| (D) (parts by weight) | 6 | 6 | 6 | 6 | 6 |
| (E1) (parts by weight) | 1.5 | 1.5 | 1.5 | 1.5 | 1.5 |
| (E2) (parts by weight) | — | — | — | — | — |
| Metal adhesion strength | 39 | 40 | 42 | 45 | 38 |
| (MPa) | | | | | |
| Dart impact strength | 87 | 90 | 96 | 81 | 94 |
| (cm) | | | | | |
| Notched Izod impact | 14.2 | 14.6 | 15.2 | 13.5 | 15.5 |
| strength (kgf · cm/cm) | | | | | |
| Flexural Modulus | 120,000 | 110,000 | 100,000 | 80,000 | 130,000 |
| (kgf/cm²) | | | | | |
| Tensile strength | 84 | 85 | 87 | 82 | 89 |
| retention rate (%) | | | | | |

*parts by weight: Parts by weight relative to 100 parts by weight of polyester resin (A)

TABLE 2

| | Example | | | |
|---|---|---|---|---|
| | 6 | 7 | 8 | 9 |
| (A) (parts by weight) | 100 | 100 | 100 | 100 |
| (B) (parts by weight) | 14.5 | 14.5 | 14.5 | 14.5 |
| (C) (parts by weight) | 92 | 92 | 92 | 92 |
| (D) (parts by weight) | 4 | 10 | 6 | 6 |
| (E1) (parts by weight) | 1.5 | 1.5 | 0.4 | 2 |
| (E2) (parts by weight) | — | — | — | — |
| Metal adhesion strength | 44 | 36 | 40 | 38 |
| (MPa) | | | | |
| Dart impact strength | 78 | 107 | 86 | 89 |
| (cm) | | | | |
| Notched Izod impact | 12.7 | 16.3 | 14.1 | 12.9 |
| strength (kgf · cm/cm) | | | | |
| Flexural modulus | 115,000 | 100,000 | 110,000 | 100,000 |
| (kgf/cm²) | | | | |
| Tensile strength | 80 | 91 | 86 | 82 |
| retention rate (%) | | | | |

*parts by weight: Parts by weight relative to 100 parts by weight of polyester resin (A).

TABLE 3

| | Comparative Example | | | | | |
|---|---|---|---|---|---|---|
| | 1 | 2 | 3 | 4 | 5 | 6 |
| (A) (parts by weight) | 100 | 100 | 100 | 100 | 100 | 100 |
| (B) (parts by weight) | 5 | 30 | 14.5 | 14.5 | 14.5 | 14.5 |
| (C) (parts by weight) | 92 | 92 | 20 | 120 | 92 | 92 |
| (D) (parts by weight) | 6 | 6 | 6 | 6 | 2 | 15 |
| (E1) (parts by weight) | 1.5 | 1.5 | 1.5 | 1.5 | 1.5 | 1.5 |
| (E2) (parts by weight) | — | — | — | — | — | — |
| Metal adhesion strength | 34 | 29 | 43 | 33 | 42 | 27 |
| (MPa) | | | | | | |
| Dart impact strength | 75 | 83 | 51 | 72 | 46 | 113 |
| (cm) | | | | | | |
| Notched Izod impact | 13.5 | 13.9 | 9.6 | 14.8 | 8.2 | 16.1 |
| strength (kgf · cm/cm) | | | | | | |
| Flexural modulus | 110,000 | 100,000 | 60,000 | 140,000 | 110,000 | 100,000 |
| (kgf/cm²) | | | | | | |
| Tensile strength | 86 | 83 | 78 | 88 | 79 | 92 |
| retention rate (%) | | | | | | |

*parts by weight: Parts by weight relative to 100 parts by weight of polyester resin (A).

TABLE 4

| | Comparative Example | | | | |
|---|---|---|---|---|---|
| | 7 | 8 | 9 | 10 | 11 |
| (A) (parts by weight) | 100 | 100 | 100 | 100 | 100 |
| (B) (parts by weight) | 14.5 | 14.5 | 14.5 | 14.5 | 14.5 |
| (C) (parts by weight) | 92 | 92 | 92 | 92 | 92 |
| (D) (parts by weight) | — | 6 | 6 | 6 | 6 |
| (E1) (parts by weight) | 0.1 | 15 | — | 0.1 | 8 |
| (E2) (parts by weight) | — | — | 1.5 | — | — |
| Metal adhesion strength | 44 | 35 | 40 | 43 | 36 |
| (MPa) | | | | | |
| Dart impact strength | 21 | 56 | 72 | 67 | 79 |
| (cm) | | | | | |
| Notched Izod impact | 5.6 | 10.5 | 12.0 | 11.9 | 12.1 |
| strength (kgf · cm/cm) | | | | | |
| Flexural modulus | 110,000 | 100,000 | 100,000 | 110,000 | 100,000 |
| (kgf/cm²) | | | | | |
| Tensile strength | 75 | 69 | 73 | 76 | 72 |
| retention rate (%) | | | | | |

*parts by weight: Parts by weight relative to 100 parts by weight of polyester resin (A).

From the results, it could be seen that the thermoplastic resin composition according to the present invention exhibited good properties in terms of metal adhesion (metal adhesion strength), impact resistance (dart impact strength and/or notched Izod impact strength), rigidity (flexural modulus), thermal stability (tensile strength retention rate), and balance therebetween.

Conversely, it could be seen that the thermoplastic resin composition of Comparative Example 1 prepared using an insufficient amount of the polycarbonate resin exhibited deterioration in metal adhesion, impact resistance, and the like; the thermoplastic resin composition of Comparative Example 2 prepared using an excess of the polycarbonate resin exhibited deterioration in metal adhesion and the like; the thermoplastic resin composition of Comparative Example 3 prepared using an insufficient amount of the flat glass fibers exhibited deterioration in impact resistance, rigidity, thermal stability and the like; and the thermoplastic resin composition of Comparative Example 4 prepared using an excess of the flat glass fibers exhibited deterioration in metal adhesion, impact resistance, and the like. In addition, it could be seen that the thermoplastic resin composition of Comparative Example 5 prepared using an insufficient amount of the epoxy-modified olefin polymer exhibited deterioration in impact resistance, thermal stability, and the like; the thermoplastic resin composition of Comparative Example 6 prepared using an excess of the epoxy-modified olefin polymer exhibited deterioration in metal adhesion and the like; the thermoplastic resin composition of Comparative Example 7 prepared using an insufficient amount of the maleic anhydride-modified polyolefin exhibited deterioration in impact resistance, thermal stability, and the like; the thermoplastic resin composition of Comparative Example 8 prepared using an excess of the maleic anhydride-modified polyolefin exhibited deterioration in metal adhesion, impact resistance, and the like; and the thermoplastic resin composition of Comparative Example 8 prepared using the maleic anhydride-modified ethylene-butene copolymer (E2) instead of the maleic anhydride-modified polyolefin according to the present invention exhibited deterioration in metal adhesion, impact resistance, thermal stability, and the like.

In addition, it could be seen that, even with the epoxy-modified olefin polymer (D) and the maleic anhydride-modified polyolefin (E) within the content ranges according to the present invention, the thermoplastic resin composition (Comparative Example 10) having a weight ratio (D:E) (1:0.017) less than 1:0.1 exhibited deterioration in impact resistance, thermal stability, and the like, and the thermoplastic resin composition (Comparative Example 11) having a weight ratio (D:E) (1:1.3) exceeding 1:1 exhibited deterioration in impact resistance, thermal stability, and the like.

Although some embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A thermoplastic resin composition comprising:
about 100 parts by weight of a polyester resin;
about 7 parts by weight to about 25 parts by weight of a polycarbonate resin;
about 30 parts by weight to about 110 parts by weight of flat glass fibers;
about 3 parts by weight to about 13 parts by weight of an epoxy-modified olefin polymer; and
about 0.2 parts by weight to about 10 parts by weight of a maleic anhydride-modified polyolefin,
wherein the epoxy-modified olefin polymer and the maleic anhydride-modified polyolefin are present in a weight ratio of about 1:0.1 to about 1:1.

2. The thermoplastic resin composition according to claim 1, wherein the polyester resin comprises at least one of polybutylene terephthalate, polyethylene terephthalate, and polycyclohexylenedimethylene terephthalate.

3. The thermoplastic resin composition according to claim 1, wherein the flat glass fibers have a rectangular or elliptical cross-section, a cross-sectional aspect ratio (cross-sectional major diameter/cross-sectional minor diameter) of about 1.5 to about 10, and a minor diameter of about 2 μm to about 10 μm.

4. The thermoplastic resin composition according to claim 1, wherein the epoxy-modified olefin polymer comprises at least one of glycidyl (meth)acrylate-modified polyethylene, a glycidyl (meth)acrylate-modified ethylene-butyl acrylate copolymer, and a glycidyl (meth)acrylate-modified ethylene-methyl acrylate copolymer.

5. The thermoplastic resin composition according to claim 1, wherein the maleic anhydride-modified polyolefin comprises at least one of maleic anhydride-modified polypropylene, maleic anhydride-modified polyethylene, and maleic anhydride-modified polybutylene.

6. The thermoplastic resin composition according to claim 1, wherein the thermoplastic resin composition has a metal adhesion strength of about 35 MPa to about 50 MPa, as measured with respect to an aluminum-based metal specimen in accordance with ISO 19095.

7. The thermoplastic resin composition according to claim 1, wherein the thermoplastic resin composition has a dart impact strength of about 76 cm to about 120 cm, as determined by measuring a height from which dropping a 500 g dart causes cracking of a 2 mm thick specimen in accordance with the DuPont drop test method, and a notched Izod impact strength of about 12.5 kgf cm/cm to about 20 kgf cm/cm, as measured on a ⅛″ thick specimen in accordance with ASTM D256.

8. The thermoplastic resin composition according to claim 1, wherein the thermoplastic resin composition has a flexural modulus of about 80,000 kgf/cm² to about 140,000 kgf/cm², as measured on a ¼″ thick specimen at a rate of 2.8 mm/min in accordance with ASTM D790.

9. The thermoplastic resin composition according to claim 1, wherein the thermoplastic resin composition has a tensile strength retention rate of about 80% or more, as calculated according to Equation 1:
$$Tensile strength retention rate ( \% ) = {TS}_{1} / {TS}_{0} \times 100 \qquad [ Equation 1 ]$$
where TS₀ is an initial tensile strength of a 3.2 mm thick specimen, as measured in accordance with ASTM D638, and TS₁ is a tensile strength of the specimen, as measured in accordance with ASTM D638 after the specimen is left in an oven at 310° C. for 3 minutes.

10. A molded article formed of the thermoplastic resin composition according to claim 1.

11. A composite material comprising:
a plastic member as the molded article according to claim 10; and
a metal member adjoining the plastic member.

12. The composite material according to claim 11, wherein the metal member directly adjoins the plastic member without a bonding agent interposed therebetween.

13. The composite material according to claim 11, wherein the metal member comprises at least one of aluminum, titanium, iron, and zinc.

14. The composite material according to claim 11, wherein the metal member comprises aluminum and the plastic member has a metal adhesion strength of about 35 MPa to about 50 MPa, as measured with respect to the metal member in accordance with ISO 19095.

15. The composite material according to claim 11, wherein the plastic member has a dart impact strength of about 76 cm to about 120 cm, as determined by measuring a height from which dropping a 500 g dart causes cracking of a 2 mm thick specimen in accordance with the DuPont drop test method, a notched Izod impact strength of about 12.5 kgf cm/cm to about 20 kgf cm/cm, as measured on a ⅛″ thick specimen in accordance with ASTM D256, a flexural modulus of about 80,000 kgf/cm² to about 140,000 kgf/cm², as measured on a ¼″ thick specimen at a rate of 2.8 mm/min in accordance with ASTM D790, and a tensile strength retention rate of about 80% or more, as calculated according to Equation 1:
$$Tensile strength retention rate ( \% ) = {TS}_{1} / {TS}_{0} \times 100 \qquad [ Equation 1 ]$$
where TS₀ is an initial tensile strength of a 3.2 mm thick specimen, as measured in accordance with ASTM D638, and TS₁ is a tensile strength of the plastic member, as measured in accordance with ASTM D638 after the specimen is left in an oven at 310° C. for 3 minutes.
